(19) United States
(12) Patent Application Publication
(10) Pub. No.: US 2015/0142470 A1
(43) Pub. Date: May 21, 2015

(54) GRAPHICAL USER INTERFACE APPARATUS FOR SEARCHING AND DISPLAYING MEDICAL CODES IN AN ELECTRONIC ANESTHESIA RECORD

(71) Applicant: David Michael Glenn, Menlo Park, CA (US)

(72) Inventor: David Michael Glenn, Menlo Park, CA (US)

(73) Assignee: David Michael Glenn, Menlo Park, CA (US)

(21) Appl. No.: 14/514,482

(22) Filed: Oct. 15, 2014

Related U.S. Application Data
(60) Provisional application No. 61/896,109, filed on Oct. 27, 2013.

(51) Int. Cl. G06F 19/00

(52) U.S. Cl. CPC G06F 19/322; G06F 19/3406
USPC 705/3

(57) ABSTRACT

An apparatus for improved searching and selecting of medical coding information for an electronic anesthesia record on a multi-function gesture-sensitive device.

### CROSS REFERENCE TO RELATED APPLICATIONS

This application claims priority under 35 U.S.C. §119 (e) to U.S. provisional patent application Ser. No. 61/896,109 filed on Oct. 27, 2013, the contents of which is hereby incorporated herein by reference in its entirety for all purposes.

### COPYRIGHT NOTICE

Pursuant to 37 C.F.R. 1.71(e), applicants note that a portion of this disclosure contains material that is subject to and for which is claimed copyright protection, such as, but not limited to, copies of paper forms, screen shots, user interfaces, electronic medical record formats, or any other aspects of this submission for which copyright protection is or may be available in any jurisdiction. The copyright owner has no objection to the facsimile reproduction by anyone or the patent document or patent disclosure, as it appears in the Patent Office patent file or records. All other rights are reserved, and all other reproduction, distribution, creation of derivative works based on the contents, public display, and public performance of the application or any part thereof are prohibited by applicable copyright law.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF INVENTION

This invention relates to a graphical user interface apparatus and method for the searching and displaying of CPT, ICD and RVS codes for an electronic anesthesia record.

### BACKGROUND OF THE INVENTION

In the United States the use of medical codes are primarily used to file healthcare claims. The code vocabularies most relevant the practice of anesthesiology are the American Medical Association (AMA) copyrighted Current Procedural Terminology (CPT), the World Health Organization's copyrighted International Classification of Diseases (ICD), and the Relative Value Scale (RVS), established by the federal government in 1992. For the anesthesiologist, a subset of the RVS published by the American Society of Anesthesiologists termed the ASA-RVS is most relevant because of its focus on anesthesia and non-anesthesia procedures including pain management services, invasive monitoring and transesophageal echocardiography procedures. Currently, the United States is transitioning from ICD-9 having approximately 16,000 codes, to ICD-10 having approximately 68,000 codes. An excellent discussion of the problems with CPT codes can be found in the background discussion of U.S. Pat. No. 5,325,293 to Dorne and U.S. Pat. No. 8,606,594 to Stern, et al.

Every medical insurance payer recognizes CPT codes as the standard by which medical procedures are described. In anesthesiology, as other medical disciplines, to completely bill for services rendered, the anesthesiologist must properly specify the one or more CPT codes, ICD codes and RVS codes. CPT codes work in tandem with ICD codes to create a comprehensive picture of medical services rendered. ICD codes describe the symptoms, area, and type of injury or disease in a patient. When listed together, ICD and CPT codes present a picture of both the diagnosis and the type of service provided to the patient by the anesthesiologist. As such it is necessary to convert CPT codes to ICD codes, and vice-versa. However, this is often difficult. The following examples are illustrative of challenges often encountered;
The CPT code for two doses of Hepatitis A vaccine, of pediatric or adolescent dosage, for intramuscular use is 90633. The ICD code for that same vaccine is V05.3.
In general, CPT codes provide more specificity than their ICD counterparts. Three doses of the above vaccine are coded in CPT as 90634, while in ICD it is still coded as V05.3. Medical coders must familiarize themselves with the equivalencies between these two code systems, and be able to freely translate one into the other.
In converting between CPT and ICD codes, medical coders must ensure that the CPT code they enter for a medical procedure makes sense with the ICD code. If a claim is submitted for a Human Papilloma Virus vaccine (CPT 90650), but list the diagnosis as acute appendicitis with generalized peritonitis (ICD-9-CM 540.0), a health insurance company would catch this error, deny the claim, and return it for correction.
Today's consolidated health care environment is creating conflicts between the two systems. Many hospitals operate outpatient facilities in which CPT coding is used instead of ICD-9-CM procedural coding. With the advent of ambulatory surgical centers and physician office surgical suites, many procedures that were once performed exclusively for inpatient services now can be performed as either inpatient or outpatient services. Consequently, two coding systems are in use for the same procedures. Medical coders have difficulty tracking frequencies or costs when the facility data contains both ICD and CPT codes.

To help alleviate these translational issues, an efficient means of bridging or commonly referred to, as crosswalking between ICD and CPT codes is required. Crosswalk databases are widely available.

Matters are further complicated by the use of RVS codes. As briefly discussed above, the RVS is a scheme used to determine how much money medical providers should be paid. It is partially used by Medicare in the United States and by nearly all Health Maintenance Organizations (HMOs). RVS assigns procedures performed by a physician or other medical provider a relative value that is adjusted by geographic region (so a procedure performed in Manhattan is worth more than a procedure performed in Dallas). This value is then multiplied by a fixed conversion factor, which changes annually, to determine the amount of payment. The RVS for each CPT code is determined using three separate factors: physician work, practice expense, and malpractice expense. The average relative weights of these are: physician work (52%), practice expense (44%), malpractice expense (4%). In the development of the RVS, the physician work (including the physician's time, mental effort, technical skill, judgment, stress and an amortization of the physician's education), the practice expense and the malpractice expense are factored into the result. The calculation of the fee includes a geographic adjustment. The RVS does not include adjustments for outcomes, quality of service, severity, or demand. For anesthesiologists, the American Society of Anesthesiology annually publishes a focused set of RVS codes, referred to as the ASA-RVS (and heretofore referred to as simply “RVS”), and a CPT-RVS crosswalk. These RVS codes are the codes most commonly used by anesthesiologists. The power of the crosswalk is that it defines the set of CPT codes most commonly required by anesthesiologists. RVS codes are very oriented to regions of the body. One of the predominate drivers of how an anesthesiologist is compensated is based on what region(s) of the body the surgeon(s) is (are) operating on. So if an RVS code is known, the CPT codes derived through the crosswalk are usually very focused to a region of the body.

Often the task of assigning proper and complete medical codes falls to accounting or clerical personnel. These individuals often lack the understanding of medical procedures to completely enumerate the services rendered by the anesthesiologist. Consequently, numerous systems and processes that help either the doctor or staff to select medical codes have been and are being developed. Some of these systems analyze patient data to derive CPT codes, while others attempt to use anatomical images or anatomical user interfaces to derive CPT codes. For example, US 2003/0200119 A1 to Lewis, et al., 2008/0273774 A1 to Mikhail, et al., 2009/0070140 A1 to Morsch, et al, and 2010/0328235 A1 to Taute, each use some type of anatomical visualization means to derive medical codes. However, each lack the 4-way correlation between CPT, ICD, RVS and anatomical acceleration needed by the anesthesiologist. Additionally, some prior art pertains to novel ways of searching for medical codes. For example, U.S. Pat. No. 6,393,404 to Waters, et al., and U.S. Pat. No. 5,483,443 to Milstein, et at., both focus on searching or deriving CPT codes and fail to recognize the utility of the ICD and RVS correlation and the need to present search results in a way useful to the anesthesiologist. A comprehensive solution particularly suitable to anesthesiology is lacking primarily because the anesthesiologist is required to provide CPT, ICD and RVS codes whereas other practitioners may only need CPT codes.

### SUMMARY OF THE INVENTION

A novel graphical user interface apparatus for displaying and selecting CPT, ICD and RVS medical codes derived through the cooperative interaction of a first, second, third and fourth sub-views. The apparatus uses a full-body anatomical representation of a human to accelerate the selection of CPT codes and additionally makes use of medical lingo terms to further enhance the quality of search results. It further correlates search results and CPT-ICD and CPT-RVS crosswalk databases to derive contextually relevant medical codes. The apparatus has the added novelty of ordering search results in a non-obvious manner to provide the anesthesiologist with the most accurate medical codes in the electronic anesthesia record. Although, the apparatus was developed within the context of the electronic anesthesia record, the concepts are broadly applicable to other practices of medicine.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is the graphical user interface for an electronic anesthesia record application of a multi-function gesture sensitive device in accordance with an embodiment of the present invention.

FIGS. 2a, 2b and 2c are the graphical user interface for selecting procedure, diagnosis, RVS values and a full-body representation of a human in accordance with an embodiment of the present invention.

FIG. 3 is the entity-relationship model used by the present invention in accordance with an embodiment of the present invention.

FIG. 4 is a flow diagram detailing how CPT in-memory search results are prioritized in accordance with an embodiment of the present invention.

FIG. 5 is a flow diagram detailing how ICD in-memory search results are prioritized in accordance with an embodiment of the present invention.

FIG. 6 is a flow diagram detailing how RVS in-memory search results are prioritized in accordance with an embodiment of the present invention.

### DETAILED DESCRIPTION OF THE INVENTION

The above deficiencies and other problems associated with medical coding in an electronic anesthesia record are reduced or eliminated by the disclosed apparatus and method as realized on a portable multi-function gesture-sensitive device. In all embodiments, the device has a gesture-sensitive display with a graphical user interface (GUI) produced by an application program operating on the portable multi-function device, one or more processors, memory and one or more modules, programs or sets of instructions stored in the memory for performing multiple functions. In some embodiments, the user interacts with the GUI primarily through touch gestures such as one or more fingers directly contacting the gesture-sensitive interface, however other means may also include, but not limited to, a stylus and kinetic motion gestures or even audio command, sounds or phrases. Instructions for performing these functions may be included in a computer program product configured for execution by one or more processors.

It shall be understood that, although the terms first, second, etc. used herein to describe various elements, these elements should not be limited to these terms. These terms are only used to distinguish one element from another. The terminology used in the description of the invention herein is for the purpose of describing particular embodiments only and is not intended to be limiting of the invention.

As used in the description of the invention and the appended claims, the singular forms “a”, “an” and “the” are intended to include the plural forms as well, unless the context clearly indicates otherwise. The term “plurality” is taken to mean zero to many occurrences. It will also be understood that the term “and/or” as used herein refers to and encompasses any/all possible combinations of one or more of the associated listed items.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The use of particular gestures is representative only and the reliance of touch-sensitivity is not a requirement as other means of enabling gestures may presently or in the future be possible. It is not implied that the use of the word “gesture” excludes the possibility of a combination of other gestures even of varying types.

The invention does not rely on any particular implementation of a multi-functional, gesture-sensitive device or any version of its operating system and any graphics displayed is not intended to convey a reliance on any particular vendor or version thereof. It shall be understood, that a person of ordinary skill in the art, if given a stock operating system could implement the various embodiments of the invention and the stock operating system has not been modified in any way by the invention, sometimes referred to as “hacks”, “jailbreaks”, “rooting” or “privilege escalations” to name a few.

It should be noted that the use of terminology such as window, sub-window, view and sub-view are representative of a concept in graphical user interface programming and are not limited in any way to one particular vendors approach. Some vendor's application programming interfaces (API) use terms like window/sub-window or panel/sub-panel. All are equivalent and exchangeable herein and convey a logical rather than a physical function, which a person of ordinary skill in programming a particular vendor's API could implement without undue experimentation.

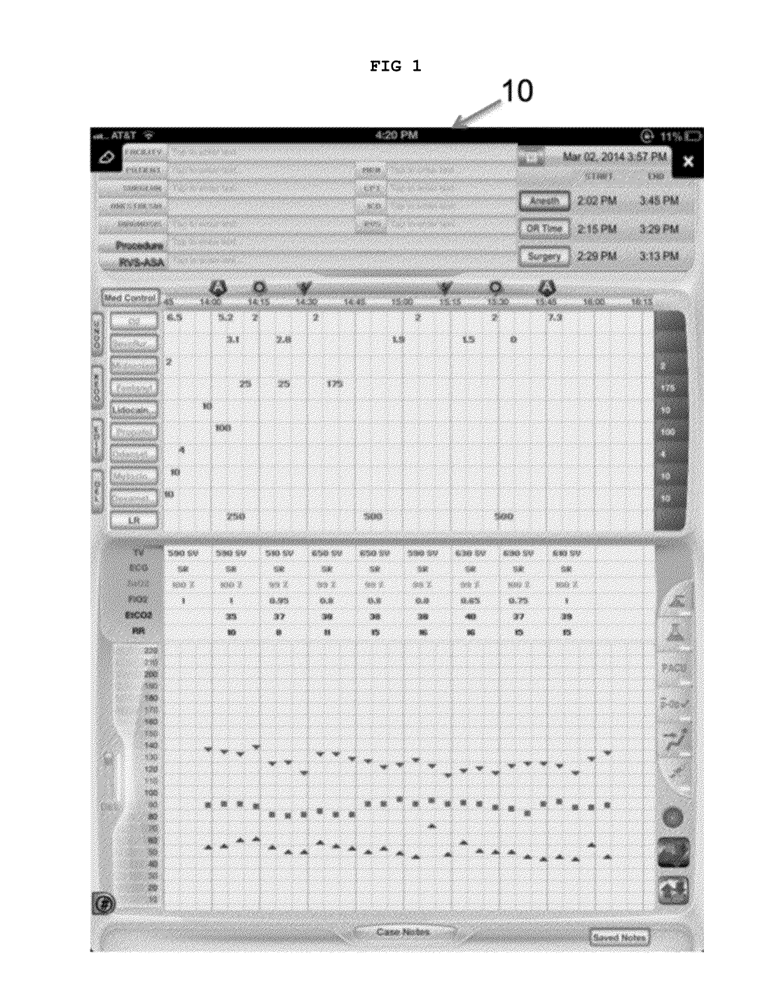

The electronic anesthesia record (FIG la) is both an apparatus and a plurality of computer-implemented methods used in conjunction with a portable multifunction device with a gesture-sensitive display and reduced to practice in the form of an application program. The application program displays an application program window (FIG. 1, 10).

Medical professionals often use medical lingo to describe procedures, actions, medical facts, etc. A lingo term can be an abbreviation, slang, or other jargon, some of which is in common knowledge or even less obvious, specific to a field of medicine. Some lingo is even specific to a hospital or region. Since medical professionals very often do not memorize CPT or ICD codes, their reliance on lingo is critical to capturing medical notes and case data on the fly. In the present invention, medical lingo serves as a keyword that can be associated to one to more CPT and/or ICD codes for a more focused search. The following is an example of this lingo:
Appy: Appendectomy
Lap-Appy: Laparoscopy. Surgical appendectomy.
Perma-Cath: Arterial catheterization for prolonged infusion therapy.

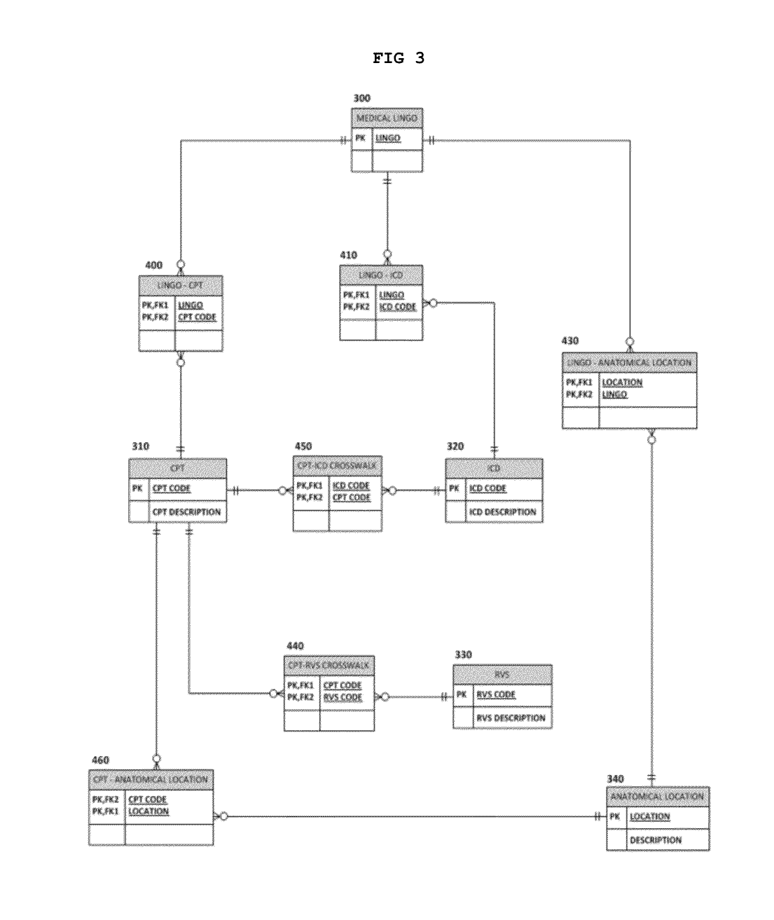

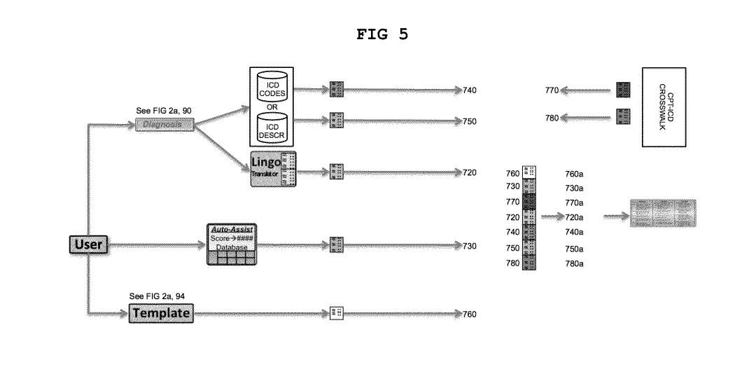

The various embodiments of the invention rely on several underlying data relationships (FIG. 5). To describe these data relationships, terminology commonly used in relational databases will be employed, however, no limitation is intended or implied. The focus is on the entities and relationships rather than a physical implementation. Medical lingo data (FIG. 3, 300) is stored in a table and keyed off of the name of the lingo, a string value. CPT data (FIG. 3, 310) is stored in a table and is keyed on the CPT code, a string. ICD data (FIG. 3, 320) is stored in a table and is keyed on ICD code. Where it is relevant, differences between the various ICD editions (ICD 9^{th} Edition and ICD 10^{th} Edition) will be described; else, simply “ICD” will be used to describe both. RVS data (FIG. 3, 330) is stored in a table and is keyed on RVS code. Anatomical location data (FIG. 3, 340) is stored in a table and is keyed on location.

There is a many-to-many relationship (FIG. 3, 400) between the medical lingo data (FIG. 3, 300) and the CPT data (FIG. 3, 310). This implies that a given medical lingo (FIG. 3, 300) may be associated to zero or more CPT codes (FIG. 3, 310) and vice-versa.

There is a many-to-many relationship (FIG. 3, 410) between medical lingo (FIG. 3, 300) and ICD codes (FIG. 3, 320). This implies that a given medical lingo (FIG. 3, 300) may be associated with zero or more ICD codes (FIG. 3, 320) and vice-versa.

There is a many-to-many relationship (FIG. 3, 430) between medical lingo (FIG. 3, 300) and anatomical locations (340). This implies that a given medical lingo (FIG. 3, 300) may be associated with zero or more anatomical locations (FIG. 3, 340) and vice-versa. This is a dynamic relationship as it will be modified by and added to by application usage. It will be preloaded with common lingos but will become larger in size and scope.

There is a many-to-many relationship (FIG. 3, 440) between CPT code (FIG. 3, 310) and RVS code (FIG. 3, 330). This implies that a given CPT code (FIG. 3, 310) may be associated with zero or more RVS codes (FIG. 3, 330) and vice-versa. This relationship is commonly referred to as a “crosswalk”. This relationship is static, but updated yearly.

There is a many-to-many relationship (FIG. 3, 450) between CPT code (FIG. 3, 310) and ICD code (FIG. 3, 320). This implies that a given CPT code (FIG. 3, 310) may be associated with zero or more ICD codes (FIG. 3, 320) and vice-versa. This relationship is also commonly referred to as a “crosswalk”. This relationship is static, but updated regularly (usually yearly).

There is a many-to-many relationship (FIG. 3, 460) between CPT code (FIG. 3, 310) and anatomical location (340). This implies that a given CPT code (FIG. 3, 310) may be associated with zero or more anatomical locations (FIG. 3, 340) and vice-versa.

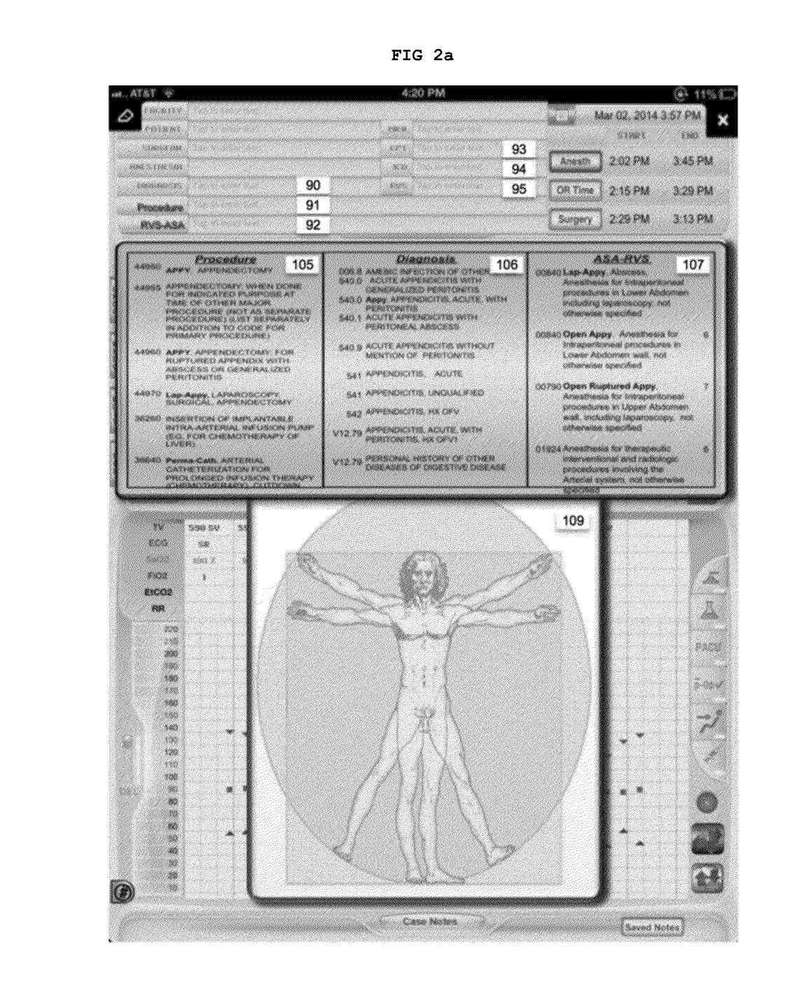

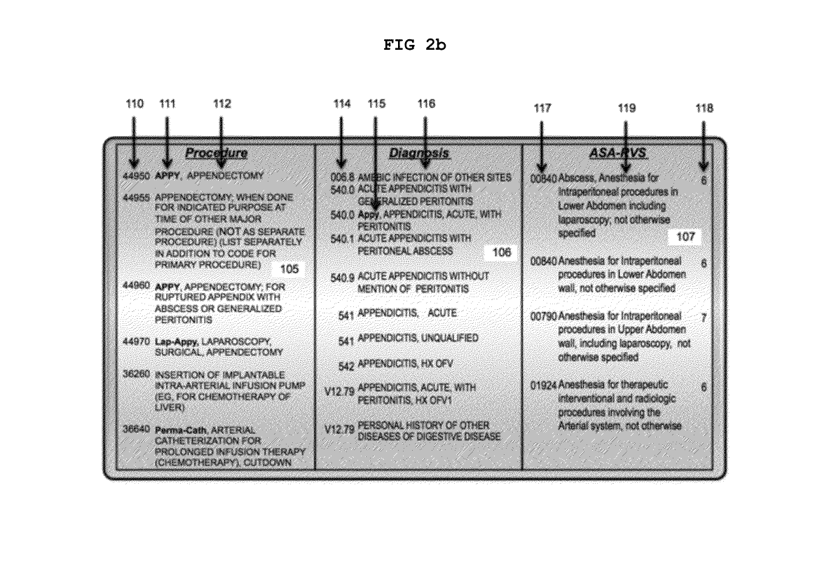

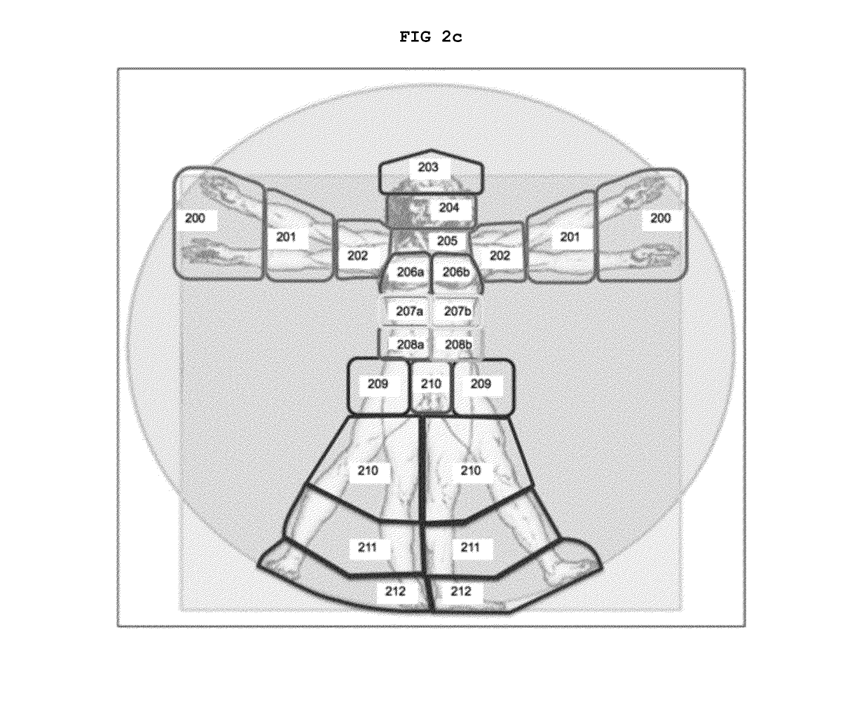

In an embodiment of the invention, the application program operatively enables, via gesture-based means, a GUI apparatus for selecting CPT, ICD and RVS codes in an electronic anesthesia record, shown within an application program window (FIG. 1, 10) on a multi-function gesture-sensitive device. The apparatus is operatively enabled to accept up to six search vectors as input. A search vector is a string of text, properly formatted, whose content is suitable for a particular purpose. The purpose of the apparatus is to enable the anesthesiologist to find the one or more CPT, ICD and RVS codes required to completely bill for services rendered. The underlying application program operates a search engine and uses the GUI apparatus to display search results to the anesthesiologist and to accept input for search modifications. The GUI contains a first (FIG. 2a, 105), second (FIG. 2a, 106), third (FIG. 2a, 107) and fourth (FIG 2a, 109) sub-view. The first sub-view (FIG. 2b, 105) displays a bidirectional, vertically scrollable list of CPT values, each CPT value comprising, a CPT code (FIG. 2b, 110), a CPT official description (FIG. 2b, 112) and one or more medical lingo terms associated to the CPT code (FIG. 2b, 111).

The second sub-view (FIG. 2b, 106) displays a bidirectional, vertically scrollable list of ICD values, each ICD value comprising, a ICD code (FIG. 2b, 114), a ICD official description (FIG. 2b, 116) and one or more medical lingo terms associated to the ICD code (FIG. 2b, 115).

The third sub-view (FIG. 2b, 107) displays a bidirectional, vertically scrollable list of RVS values, each RVS value comprising, a RVS code (FIG. 2b, 117), a RVS official description (FIG. 2b, 119), and a relative value unit (RVU) (FIG. 2b, 118). The RVU when multiplied by a dollar amount determines what the anesthesiologist is paid. By displaying the RVU, the anesthesiologist can choose an RVS code(s) to get the highest possible RVU, hence maximizing the money paid by the insurer. Sometimes, depending on the insurer, if the anesthesiologist performs multiple, different procedures during a surgery, the insurer may not reimburse for each since the services essentially overlap. In such a case, the anesthesiologist will not know what the insurer will do when they get the bill, so they submit it with all possible RVS codes.

The fourth sub-view (FIG. 2a, 109) displays a full-body anatomical representation of a human. Anesthesiologists tend to think in terms of anatomical regions since the RVS codes (and hence, the RVUs) are region oriented which drives billable value. The full-body representation is comprised of the following characteristics, but not limited to these:
1. Two or three-dimensional.
2. Male or female.
3. Enabled to show cross-sectional views of the human body such as the body without skin or without muscle or with organs removed for enhanced visibility. The anesthesiologist will drill down from broader representations to more narrow representations.
4. Rotatable via a gesture control.
5. Zoomable via a gesture control.
6. The full-body image is divided into gesture-sensitive regions. Some regions, such as in FIG. 2c, 200, 201, 202, 203, 204, 205, are medically identical aside from their designation as left or right. Other regions such as 206a, 206b, 207a, 207b, 208a and 208b are distinct regions beyond their designation as left or right.

To better understand the invention as a whole, the discussions will first focus on how CPT, ICD and RVS search results are derived and ordered in isolation of the effects each search vector has on the others. Finally, the discussion will consider the effect crosswalks have on the search results. The discussion will now focus on how CPT search results are derived through the various search vectors and ordered (FIG. 2a, 105). For reference sake, this shall be referred to as the “primary CPT search”.

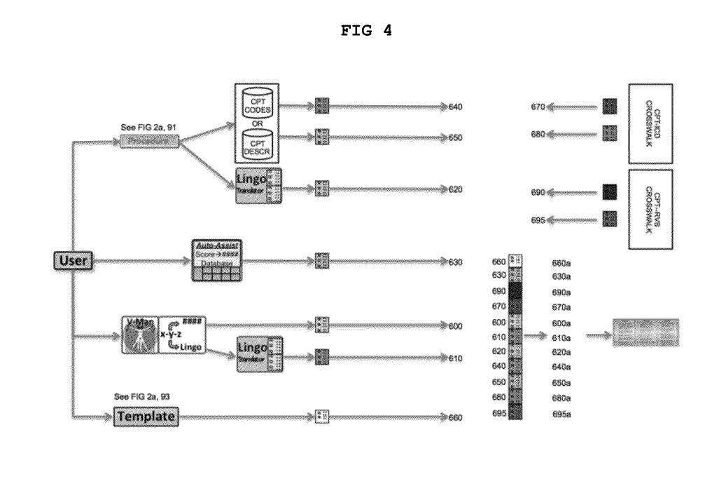

When the electronic anesthesia record is saved, the CPT, ICD and RVS codes derived by using the apparatus represent learned knowledge. The relationships between the three code types can and often do recur. Therefore, the application program provides the anesthesiologist with the ability to make a template from scratch, or from a previously saved record. For the anesthesiologist, a template, in part, represents a way to maximize billable value, because codes used in the past with success will likely translate into future success. In the context of the present invention, the saved CPT, ICD and RVS codes from the template are put into UI fields by the application program (FIG. 2a 93, FIG. 2a 94, FIG. 2a 95). Input for the forth, fifth, and sixth search vectors are derived from these three fields. The application program lists the CPT codes in the forth search vector at the top of the first sub-view. Ordering from left to right in the fourth vector results in a top to bottom ordering in the first sub-view. These CPT codes always occupy these positions irrespective of subsequent searches derived from first, second or third search vectors and appear selected in the UI (a check mark on the left side of the row). Therefore, up to this point, the in-memory CPT search result priority is:
1. CPT codes derived from the forth search vector (FIG. 4, 660).

The first search vector will be construed as either one or more CPT numerical codes, separated by a space or comma, or the text of a CPT official description. Partial CPT numerical codes are also accepted. As the anesthesiologist types each new alphanumeric character into a procedure user interface control (FIG. 2a, 91), the application program will update the first search vector and the apparatus will take action accordingly. If the first search vector contains one or more whole or partial CPT numeric codes, the apparatus will search the CPT numerical codes from the CPT table (FIG. 3, 310) such that a first search vector value of “12” will match “1245” or “1289” or “1280”. If the first search vector is not a whole or partial CPT numerical code, then the apparatus will perform a first and second search. The first search is of the CPT official description from the CPT table (FIG. 3, 310) such that a search vector of “In” will case-insensitive match “when done for the indicated purpose . . . ”. The first search prioritizes matches that contain the search vector at the beginning of words. Official descriptions that contain the string of letters within the body of words are also presented to the user but at the bottom of the search result. This is because often procedures in surgery are nicknamed by the abbreviations of the primary words of that procedure (i.e. Appy for Appendectomy), also common acronyms and hyphenated terms are used (i.e. TURP Transurethral Retrograde Prostatectomy, CS for Cesarean Section, ACL for Anterior Cruciate Ligament Repair). The second search attempts to match, either wholly or partly, the text entered against a medical lingo (FIG. 3, 300). One or more hits may result. For each hit found in the medical lingo table (FIG. 3, 300), a list of CPT codes is derived from the Lingo-CPT relationship (FIG. 3, 400). The final search result being the sum of the CPT codes from the first and second search hits, with duplicates removed and with the results of the second search having priority. The results of second search are given priority because the association of medical lingo to CPT codes is developed by the anesthesiologist and has a more deliberate ordering. Therefore, up to this point, the in-memory CPT search result priority is:
1. CPT codes derived from the forth search vector (FIG. 4, 660).
2. CPT codes derived by hits through medical lingos (FIG. 4, 620).
3. Hits that occur at the beginning of a word in the official CPT description (FIG. 4, 640).
4. Hits that occur in the body of words in the official CPT description (FIG. 4, 650).

As discussed above, the fourth sub-view provides an anatomical representational of a human. The representation is divided into regions; each region has two data associations, zero to many CPT codes (FIG. 3, 460) and zero to many medical lingos (FIG. 3, 430). When an anesthesiologist gestures over a region, the application program adds the associated CPT code(s) to the search result. Therefore, up to this point, the in-memory CPT search result priority is:
1. CPT codes derived from the forth search vector (FIG. 4, 660).
2. CPT codes received from the relationship between an anatomical region and a CPT code (FIG. 3, 460) (FIG. 4, 600).
3. CPT codes derived by the relationship between anatomical region and medical lingo to CPT (FIG. 3, 400) (FIG. 4, 610).
4. CPT codes derived by hits through medical lingos (FIG. 4, 620).
5. Hits that occur at the beginning of a word in the official CPT description or the numerical CPT code (FIG. 4, 640).
6. Hits that occur in the body of words in the official CPT description (FIG. 4, 650).

Demographic content pertinent to an electronic anesthesia record can be a source of CPT coding information. Such demographic content may be comprised of, but not limited to, patient age group (neonatal, pediatric, child, adult, geriatric, etc.), gender, the department of a treatment center (urology, gynecology, pediatrics, etc.), facility, anesthesiologist and surgeon. The application program gives users the ability to configure relationships between CPT codes and the demographic content, the result being a tightly correlated CPT code to the present record. For example, Surgeon Jones only operates on the feet of infants with birth defects. Therefore, the most likely CPT codes used in a Jones case are necessarily very narrow and in many cases the correlation is exact. The process of configuring the relationships between CPT codes and the demographic content is beyond the scope of the present invention and not shown. The application program will query the demographics database with the afore mentioned record information, derive CPT code(s) and place them into the search result according to the following overall priority:
1. CPT codes derived from the forth search vector (FIG. 4, 660). If the fourth search vector has no content, no CPT codes are added by this step.
2. CPT codes derived from the demographics database (FIG. 4, 630).
3. CPT codes received from the relationship between an anatomical region and a CPT code (FIG. 3, 460) (FIG. 4, 600).
4. CPT codes derived by the relationship between anatomical region and medical lingo to CPT (FIG. 3, 400) (FIG. 4, 610).
5. CPT codes derived by hits through medical lingos (FIG. 4, 620).
6. Hits that occur at the beginning of a word in the official CPT description or the CPT numerical code (FIG. 4, 640).
7. Hits that occur in the body of words in the official CPT description (FIG. 4, 650).

Next we turn to understanding how ICD search results are derived and ordered (FIG. 2a, 106). For reference sake, this shall be referred to as the “primary ICD search”. As discussed above, when the electronic anesthesia record is saved, the CPT, ICD and RVS codes derived by using the apparatus represent learned knowledge. In the context of the present invention, the saved ICD codes from the template are put into UI fields by the application program (FIG. 2a 94). Input for the fifth search vectors is derived from this field. Therefore, up to this point, the in-memory ICD search result priority is:
1. ICD codes derived from the fifth search vector (FIG. 5, 760).

The application program will construe the second search vector as either one or more ICD numerical codes, separated by a space or comma, or the text of an ICD official description. Partial ICD numerical codes are also accepted. The anesthesiologist will type each new alphanumeric character into a diagnosis input field (FIG. 2a, 90), the application program will update the second search vector and the apparatus will take action accordingly. If the second search vector contains one or more whole or partial ICD numeric code, the apparatus will search the ICD numerical codes from the ICD table (FIG. 3, 320) such that a second search vector value of “12” will match “1245” or “1289” or “1280”. If the second search vector does not contain a whole or partial ICD numerical code, then the apparatus will perform a first and second search. The first search is of the ICD description from the ICD table (FIG. 3, 320) such that a user entry of “In” will case-insensitive match “when done for the indicated purpose . . . ”. The first search prioritizes the ICD official descriptions that contain the user-entered string of letters, at the beginning of words. Texts that contain the string of letters within the body of words in the ICD official descriptions are also presented to the user but later in the search result. This is because often procedures in surgery are nicknamed by the abbreviations of the primary words of that procedure (i.e. “Appy” for Appendectomy), also common acronyms and hyphenated terms are used (i.e. TURP Transurethral Retrograde Prostatectomy, CS for Cesarean Section, ACL for Anterior Cruciate Ligament Repair). The second search attempts to match, either wholly or partly, the text entered against a medical lingo (FIG. 3, 300). One or more hits may result. For each hit found in the medical lingo table (FIG. 3, 300), a list of ICD codes is derived from the Lingo-ICD relationship (FIG. 3, 410). The final search result being the sum of the ICD codes from the first and second search hits, with duplicates removed and with the results of the second search having priority. The results of second search are given priority because the association of medical lingo to ICD codes is developed by the user and has a more deliberate ordering. Therefore, up to this point, the in-memory ICD search result priority is:
1. ICD codes derived from the fifth search vector (FIG. 5, 760).
2. ICD codes derived by hits through medical lingos (FIG. 5, 720).
3. Hits that occur at the beginning of a word in the official ICD description or the ICD numerical code (FIG. 5, 740).
4. Hits that occur in the body of words in the official ICD description (FIG. 5, 750).

As discussed above, demographic content pertinent to an electronic anesthesia record can also be a source of ICD coding information as well. The application program will query the demographics database and derive ICD code(s) and place them into the search result according to the following overall priority:
1. ICD codes derived from the fifth search vector (FIG. 5, 760).
2. ICD codes derived from the demographics database (FIG. 5, 730).
3. ICD codes derived by hits through medical lingos (FIG. 5, 720).
4. Hits that occur at the beginning of a word in the official ICD description or the ICD numerical code (FIG. 5, 740).
5. Hits that occur in the body of words in the official ICD description (FIG. 5, 750).

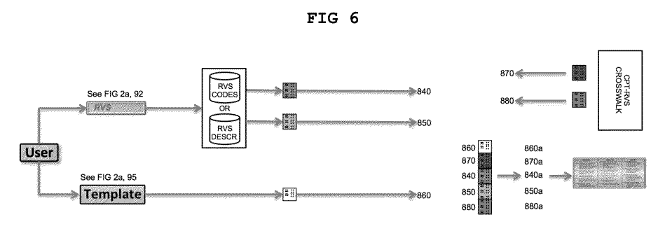

Next we turn to understanding how RVS search results are derived and ordered (FIG. 2a, 107). For reference sake, this shall be referred to as the “primary RVS search”. As discussed above, when the electronic anesthesia record is saved, the CPT, ICD and RVS codes derived by using the apparatus represent learned knowledge. In the context of the present invention, the saved RVS codes from the template are put into UI fields by the application program (FIG. 2a 95). Input for the sixth search vectors is derived from this field. Therefore, up to this point, the in-memory RVS search result priority is:
1. RVS codes derived from the sixth search vector (FIG. 6, 860).

The third search vector will be construed as either one or more RVS numerical codes, separated by a space or comma, or the text of an RVS official description. Partial RVS numerical codes are also accepted. As the anesthesiologist types each new alphanumeric character into a RVS input field (FIG. 2a, 92), the application program will update the third search vector and the apparatus will take action accordingly. If the third search vector contains one or more whole or partial RVS numeric code, the apparatus will search the RVS numerical codes from the RVS table (FIG. 3, 330) such that a third search vector value of “12” will match “1245” or “1289” or “1280”. If the third search vector does not contain a whole or partial RVS numerical code, then the apparatus will perform a search of the RVS official description from the RVS table (FIG. 3, 330) such that a user entry of “In” will case-insensitive match “when done for the indicated purpose . . . ”. The search prioritizes the RVS texts that contain the user-entered string of letters, at the beginning of words. Texts that contain the string of letters within the body of words in the RVS texts are also presented to the user but at the bottom of the search result. In this regard, the rational is the same as the first and second search vectors. The overall search result priority is
1. RVS codes derived from the sixth search vector (FIG. 6, 860).
2. Hits that occur at the beginning of a word in the official RVS description (FIG. 6, 840).
3. Hits that occur in the body of words in the official RVS description (FIG. 6, 850).

Before proceeding, to better understand the present invention, a few scenarios will be discussed in light of the processes described above. Briefly, to recap, we have discussed the effect each search vector has on the apparatus and how search results are produced. The scenarios below will serve to better explain these interactions better.

First, we will consider the scenario where none of the search vectors have content prior to the application program opening the apparatus. In such as case, the first, second and third sub-views have nothing to display. The anesthesiologist then begins entering text into the procedure field (FIG. 2a, 91). This text forms the content for the first search vector. As the anesthesiologist types, CPT values (CPT codes, official descriptions and associated medical lingo) are continuously updated in the first sub-view (FIG. 2a, 105) according to the process described above. Since the second-sixth search vectors have no content, the second and third sub-views show no ICD or RVS values. Similarly, if the anesthesiologist had entered content into the diagnosis field (FIG. 2a, 90) instead of the procedure field (FIG. 2a, 91), then only the second sub-view (FIG. 2a, 106) would show values since only the second search vector had content. Again, similarly, if the anesthesiologist had entered content only into the RVS field (FIG. 2a, 92) instead of the procedure or diagnosis fields, then only the third sub-view (FIG. 2a, 107) would show values since only the third search vector had content.

In the next scenario, we describe the behavior of the application program when the fourth, fifth and sixth search vectors contain content. One permutation where this would happen is if an electronic anesthesia record were created from a template which had previously decided CPT, ICD and RVS codes and will appear when the record is displayed (FIG. 2a 93, FIG. 2a 94, FIG. 2a 95). In such a case, the application program will execute the search processes for CPT, ICD and RVS codes as described above and display the results in the first (FIG. 2a, 105), second (FIG. 2a, 106) and third (FIG. 2a, 107) sub-views.

Next, the discussion turns to the effect user interaction has on the apparatus and the search process. This discussion will also detail the interaction between search vector results and the resulting effect on search results and search result ordering. Once the apparatus has displayed search results, the anesthesiologist must select which (possibly additional) CPT, ICD and RVS codes to associate to the record. This is accomplished by performing a gesture (single finger tap) on a row in the first, second or third sub-views. When the anesthesiologist gestures over a CPT/ICD/RVS value in a particular sub-view, a secondary search is triggered which results in an interplay between the primary search results obtained by the processes above. For reference sake, these search results shall be called the “secondary search”. The following process exemplifies the search process related to the coordination between the first and second search vectors.
The application program performs the primary CPT search as described above, the result being a set of CPT codes (TABLE 1b, COLUMN A).
The application program performs the primary ICD search as described above, the results being a set of ICD codes (TABLE 1b, COLUMN B).
The anesthesiologist selects CPT-8, CPT-9 and CPT-10 in the first sub-view (FIG. 2a, 105) and the application program moves them to the top of the display list in selection order (TABLE 1b, COLUMN C). The application program derives an in-memory list of ICD codes through the CPT-ICD crosswalk (FIG. 3, 450) for the selected CPT-8, CPT-9 and CPT-10. See TABLE 1a. When viewed from the perspective of the CPT codes, the crosswalk adds ICD-P to the primary ICD search results (ICD-P comprises the “secondary ICD search”). The ICD codes derived through the primary and secondary ICD search have codes ICD-O, ICD-R, and ICD-Z in common, so the application program prioritizes them higher in the search result since they represent ICD codes of high interest to the anesthesiologist (FIG. 5, 770 and TABLE 1b, COLUMN D). Secondary ICD search results not in common with the primary ICD search results are prioritized lower (FIG. 5, 780) as results brought in exclusively through a crosswalk have the lowest priority.
The anesthesiologist selects ICD-Z in the second sub-view (FIG. 2a, 106) and the application program moves it to the top of the display list (TABLE 1c, COLUMN D). The application program derives a list of CPT values through the CPT-ICD crosswalk for only ICD-Z. When viewed from the perspective of the ICD codes, the crosswalk adds CPT-11 and CPT-12 to the primary CPT search results, (CPT-11 and CPT-12 comprise the “secondary CPT search”). The secondary CPT search has no values in common with the primary CPT search (FIG. 4, 670 as no values), so CPT-11 and CPT-12 are placed towards the bottom of the list (FIG. 4, 680). The final CPT results being TABLE 1c, COLUMN C.

TABLE 1a

| CPT TABLE | CPT-ICD CROSSWALK TABLE | | ICD TABLE |
|---|---|---|---|
| (FIG. 3, 310) | (FIG. 3, 450) | | (FIG. 3, 320) |
| CPT CODE | CPT CODE | ICD CODE | ICD CODE |
| CPT-1 | CPT-1 | ICD-H | ICD-H |
| CPT-2 | CPT-2 | ICD-I | ICD-I |
| CPT-3 | CPT-3 | ICD-J | ICD-J |
| CPT-4 | CPT-4 | ICD-K | ICD-K |
| CPT-5 | CPT-5 | ICD-L | ICD-L |
| CPT-6 | CPT-6 | ICD-M | ICD-M |
| CPT-7 | CPT-7 | ICD-N | ICD-N |
| CPT-8 | CPT-8 | ICD-O | ICD-O |
| CPT-9 | CPT-9 | ICD-P | ICD-P |
| CPT-10 | CPT-10 | ICD-R | ICD-R |
| CPT-11 | CPT-11 | ICD-Z | ICD-Z |
| CPT-12 | CPT-12 | ICD-Z | |
| | | ICD-Z | |

TABLE 1b

| A | B | | |
|---|---|---|---|
| RESULT | RESULT | C | D |
| OF FIRST | OF SECOND | DISPLAYED | DISPLAYED |
| SEARCH | SEARCH | CPT CODES | ICD CODES |
| VECTOR | VECTOR | IN FIRST | IN SECOND |
| (CPT CODES) | (ICD CODES) | SUB-VIEW | SUB-VIEW |
| CPT-1 | ICD-O | CPT-8 | ICD-O |
| CPT-2 | ICD-R | CPT-9 | ICD-R |
| CPT-3 | ICD-Z | CPT-10 | ICD-Z |
| CPT-4 | | CPT-1 | ICD-P |
| CPT-5 | | CPT-2 | |
| CPT-6 | | CPT-3 | |
| CPT-7 | | CPT-4 | |
| CPT-8 | | CPT-5 | |
| CPT-9 | | CPT-6 | |
| CPT-10 | | CPT-7 | |

TABLE 1c

| A | B | | |
|---|---|---|---|
| RESULT | RESULT | C | D |
| OF FIRST | OF SECOND | DISPLAYED | DISPLAYED |
| SEARCH | SEARCH | CPT CODES | ICD CODES |
| VECTOR | VECTOR | IN FIRST | IN SECOND |
| (CPT CODES) | (ICD CODES) | SUB-VIEW | SUB-VIEW |
| CPT-1 | ICD-O | CPT-8 | ICD-Z |
| CPT-2 | ICD-R | CPT-9 | ICD-O |
| CPT-3 | ICD-Z | CPT-10 | ICD-R |
| CPT-4 | | CPT-1 | ICD-P |
| CPT-5 | | CPT-2 | |
| CPT-6 | | CPT-3 | |
| CPT-7 | | CPT-4 | |
| CPT-8 | | CPT-5 | |
| CPT-9 | | CPT-6 | |
| CPT-10 | | CPT-7 | |
| | | CPT-11 | |
| | | CPT-12 | |

Next, we expand the discussion and turn to the search process related to the coordination between the first and third search results. The process is analogous to search process for the first and second search vectors and is as follows.
The application program performs the primary CPT search as described above, the result being a set of CPT codes (TABLE 2b, COLUMN A).
The application program performs the primary RVS search as described above, the results being a set of RVS codes (TABLE 2b, COLUMN B).
The anesthesiologist selects CPT-8, CPT-35 and CPT-66 in the first sub-view (FIG. 2b, 105) and the application program moves them to the top of the display list in selection order (TABLE 2b, COLUMN C). The application program derives an in-memory list of RVS codes through the CPT-RVS crosswalk (FIG. 3, 440) for the selected CPT-8, CPT-35 and CPT-66 codes. See TABLE 2a. When viewed from the perspective of the CPT codes, the crosswalk adds RVS-12, RVS-16, and RVS-18 to the primary RVS search results (RVS-12, RVS-16, and RVS-18 comprise the “secondary RVS search”). The RVS codes derived through the primary and secondary RVS search have codes RVS-16, RVS-18 in common, so the application program prioritizes them higher in the search result (FIG. 6, 870 and TABLE 2b, COLUMN D) since they represent RVS codes of high interest to the anesthesiologist. Secondary RVS search results not in common with the primary RVS search results (RVS-5) are prioritized lower (FIG. 6, 880) as results brought in exclusively through a crosswalk have the lowest priority.
The anesthesiologist select RVS-5 in the third sub-view (FIG. 2a, 107) and the application program moves it to the top of the display list (TABLE 2c, COLUMN D). The application program derives a list of CPT values through the CPT-RVS crosswalk for only RVS-5. When viewed from the perspective of the RVS codes, the crosswalk adds CPT-1 to the primary CPT search results, (CPT-1 comprises the “secondary CPT search”). The secondary CPT search has no values in common with the primary CPT search (FIG. 4, 690 has no results), so CPT-1 is placed towards the bottom of the list (FIG. 4, 695). The final CPT results being TABLE 2c, COLUMN C.

TABLE 2a

| CPT TABLE | CPT-RVS CROSSWALK TABLE | | RVS TABLE |
|---|---|---|---|
| (FIG. 3, 310) | (FIG. 3, 440) | | (FIG. 3, 330) |
| CPT_CODE | CPT_CODE | RVS_CODE | RVS_CODE |
| CPT-1 | CPT-1 | RVS-5 | RVS-5 |
| CPT-2 | CPT-2 | RVS-6 | RVS-6 |
| CPT-3 | CPT-3 | RVS-8 | RVS-8 |
| CPT-8 | CPT-8 | RVS-12 | RVS-12 |
| CPT-35 | CPT-35 | RVS-16 | RVS-16 |
| CPT-66 | CPT-66 | RVS-18 | RVS-18 |
| CPT-89 | CPT-89 | RVS-19 | RVS-19 |
| | CPT-89 | RVS-23 | RVS-23 |
| | CPT-89 | RVS-26 | RVS-26 |
| | CPT-89 | RVS-29 | RVS-29 |

TABLE 2b

| A | | | |
|---|---|---|---|
| RESULT | B | | |
| OF FIRST | RESULT | C | D |
| SEARCH | OF THIRD | DISPLAYED | DISPLAYED |
| VECTOR | SEARCH | CPT CODES | RVS CODES |
| (CPT | VECTOR | IN FIRST | IN THIRD |
| CODES) | (RVS CODES) | SUB-VIEW | SUB-VIEW |
| CPT-2 | RVS-5 | CPT-8 | RVS-16 |
| CPT-3 | RVS-16 | CPT-35 | RVS-18 |
| CPT-8 | RVS-18 | CPT-66 | RVS-5 |
| CPT-35 | | CPT-2 | |
| CPT-66 | | CPT-3 | |
| CPT-89 | | CPT-89 | |

TABLE 2c

| A | B | | |
|---|---|---|---|
| RESULT | RESULT | C | D |
| OF FIRST | OF THIRD | DISPLAYED | DISPLAYED |
| SEARCH | SEARCH | CPT CODES | RVS CODES |
| VECTOR | VECTOR | IN FIRST | IN THIRD |
| (CPT CODES) | (RVS CODES) | SUB-VIEW | SUB-VIEW |
| CPT-2 | RVS-5 | CPT-8 | RVS-5 |
| CPT-3 | RVS-16 | CPT-35 | RVS-16 |
| CPT-8 | RVS-18 | CPT-66 | RVS-18 |
| CPT-35 | | CPT-1 | |
| CPT-66 | | CPT-2 | |
| CPT-89 | | CPT-3 | |
| | | CPT-89 | |

Next, and again, we expand the discussion and turn to the search process related to the coordination between the first, second and third search vectors. The data used in the discussion is independent of that used in the previous two discussions. The process is as follows.
The application program performs the primary CPT search as described above, the result being a set of CPT codes (TABLE 3b, COLUMN A).
The application program performs the primary ICD search as described above, the results being a set of ICD codes (TABLE 3b, COLUMN B).
The application program performs the primary RVS search as described above, the results being a set of RVS codes (TABLE 3b, COLUMN C).
The anesthesiologist selects CPT-35 in the first sub-view (FIG. 2a, 105) and the application program moves it to the top of the displayed list of CPT values (TABLE 3b, COLUMN D). The application program derives an in-memory list of ICD codes through the CPT-ICD crosswalk (FIG. 3, 450) for the CPT-35. See TABLE 3a. When viewed from the perspective of the CPT codes, the crosswalk adds ICD-E, ICD-F, ICD-G, and ICD-H to the primary ICD search results (ICD-E, ICD-F, ICD-G, and ICD-H comprise the “secondary ICD search”). The ICD codes derived through the primary and secondary ICD search have no codes in common. Secondary ICD search results not in common with the primary ICD search results are prioritized lower (FIG. 5, 780) as results brought in exclusively through a crosswalk have the lowest priority. In addition, the application program derives an in-memory list of RVS codes through the CPT-RVS crosswalk (FIG. 3, 440) for CPT-35. When viewed from the perspective of the CPT codes, the crosswalk adds RVS-40 to the primary RVS search results (RVS-40 comprises the “secondary RVS search”). The RVS code(s) derived through the primary and secondary RVS search have no codes in common. Secondary RVS search results not in common with the primary CPT search results are prioritized lower (FIG. 6, 880) as results brought in exclusively through a crosswalk have the lowest priority.
The anesthesiologist selects ICD-D and ICD-W in the second sub-view (FIG. 2a, 106) and the application program moves them to the top of the displayed list of ICD values (TABLE 3c, COLUMN E). The application program derives a list of CPT values through the CPT-ICD crosswalk for ICD-D and ICD-W. When viewed from the perspective of the ICD codes, the crosswalk adds CPT-101 and CPT-230 to the primary CPT search results, (CPT-101 and CPT-230 comprise the “secondary CPT search”). The secondary CPT search has CPT-8 in common with the primary CPT search, so CPT-8 is moved higher in the list (FIG. 4, 670). CPT-101 and CPT-230 are not in common with the primary CPT search results, so they are placed towards the bottom of the list (FIG. 4, 680). The final CPT results being TABLE 3c, COLUMN D.
The anesthesiologist select RVS-8 in the third sub-view (FIG. 2a, 107) and the application program moves it to the top of the display list (TABLE 3c, COLUMN D). The application program derives a list of CPT values through the CPT-RVS crosswalk for only RVS-8. When viewed from the perspective of the RVS codes, the crosswalk adds CPT-38 and CPT-67 to the primary CPT search results, (CPT-38 and CPT-67 comprises the “secondary CPT search”). The secondary CPT search has CPT-8 in common with the primary CPT search (FIG. 4, 680); however, CPT-8 is already in its correct position, so no change. CPT-38 and CPT-67 are not in common with the primary CPT search results, so they are placed towards the bottom of the list (FIG. 4, 695). The final CPT results being TABLE 3d, COLUMN D. CPT-38 related to ICD-L and CPT-67 is related to ICD-P through the CPT-ICD crosswalk (FIG. 3, 450), hence ICD-L and ICD-P are added towards to bottom of the ICD search results (FIG. 5, 780) because they have no values in common with the primary ICD search results.

TABLE 3a

| CPT TABLE | CPT-ICD | | ICD TABLE | CPT-RVS | | RVS TABLE |
|---|---|---|---|---|---|---|
| (FIG. 3, | CROSSWALK TABLE | | (FIG. 3, | CROSSWALK TABLE | | (FIG. 3, |
| 310) | (FIG. 3, 450) | | 320) | (FIG. 3, 440) | | 330) |
| CPT_CODE | CPT_CODE | ICD_CODE | ICD_CODE | CPT_CODE | RVS_CODE | RVS_CODE |
| CPT-1 | CPT-1 | ICD-A | ICD-A | CPT-1 | RVS-4 | RVS-4 |
| CPT-2 | CPT-2 | ICD-B | ICD-B | CPT-2 | RVS-6 | RVS-6 |
| CPT-4 | CPT-4 | ICD-C | ICD-C | CPT-8 | RVS-8 | RVS-8 |
| CPT-8 | CPT-8 | ICD-D | ICD-D | CPT-38 | RVS-8 | |
| CPT-35 | CPT-35 | ICD-E | ICD-E | CPT-67 | RVS-8 | |
| | CPT-35 | ICD-F | ICD-F | CPT-2 | RVS-11 | RVS-11 |
| | CPT-35 | ICD-G | ICD-G | | RVS-12 | RVS-12 |
| | CPT-35 | ICD-H | ICD-H | CPT-35 | RVS-40 | RVS-40 |
| CPT-38 | CPT-38 | ICD-L | ICD-L | | | |
| CPT-67 | CPT-67 | ICD-P | ICD-P | | | |
| CPT-101 | CPT-101 | ICD-W | ICD-W | | | |
| CPT-230 | CPT-230 | ICD-W | | | | |
| CPT-400 | CPT-400 | ICD-Z | ICD-Z | CPT-400 | RVS-50 | RVS-50 |

TABLE 3b

| A | B | C | | | |
|---|---|---|---|---|---|
| RESULT | RESULT | RESULT | D | E | F |
| OF FIRST | OF SECOND | OF THIRD | DISPLAYED | DISPLAYED | DISPLAYED |
| SEARCH | SEARCH | SEARCH | CPT CODES | ICD CODES | RVS CODES |
| VECTOR | VECTOR | VECTOR | IN FIRST | IN SECOND | IN THIRD |
| (CPT CODES) | (ICD CODES) | (RVS CODES) | SUB-VIEW | SUB-VIEW | SUB-VIEW |
| CPT-1 | ICD-A | RVS-4 | CPT-35 | ICD-A | RVS-4 |
| CPT-2 | ICD-B | RVS-6 | CPT-1 | ICD-B | RVS-6 |
| CPT-4 | ICD-D | RVS-8 | CPT-2 | ICD-D | RVS-8 |
| CPT-8 | ICD-W | RVS-50 | CPT-8 | ICD-W | RVS-50 |
| CPT-35 | | | CPT-4 | ICD-E | RVS-40 |
| | | | | ICD-F | |
| | | | | ICD-G | |
| | | | | ICD-H | |

TABLE 3c

| A | B | C | | | |
|---|---|---|---|---|---|
| RESULT | RESULT | RESULT | D | E | F |
| OF FIRST | OF SECOND | OF THIRD | DISPLAYED | DISPLAYED | DISPLAYED |
| SEARCH | SEARCH | SEARCH | CPT CODES | ICD CODES | RVS CODES |
| VECTOR | VECTOR | VECTOR | IN FIRST | IN SECOND | IN THIRD |
| (CPT CODES) | (ICD CODES) | (RVS CODES) | SUB-VIEW | SUB-VIEW | SUB-VIEW |
| CPT-1 | ICD-A | RVS-4 | CPT-35 | ICD-D | RVS-4 |
| CPT-2 | ICD-B | RVS-6 | CPT-8 | ICD-W | RVS-6 |
| CPT-4 | ICD-D | RVS-8 | CPT-1 | ICD-A | RVS-8 |
| CPT-8 | ICD-W | RVS-50 | CPT-2 | ICD-B | RVS-50 |
| CPT-35 | | | CPT-4 | ICD-E | |
| | | | CPT-101 | ICD-F | |
| | | | CPT-230 | ICD-G | |
| | | | | ICD-H | |

TABLE 3d

| A | B | C | | | |
|---|---|---|---|---|---|
| RESULT | RESULT | RESULT | D | E | F |
| OF FIRST | OF SECOND | OF THIRD | DISPLAYED | DISPLAYED | DISPLAYED |
| SEARCH | SEARCH | SEARCH | CPT CODES | ICD CODES | RVS CODES |
| VECTOR | VECTOR | VECTOR | IN FIRST | IN SECOND | IN THIRD |
| (CPT CODES) | (ICD CODES) | (RVS CODES) | SUB-VIEW | SUB-VIEW | SUB-VIEW |
| CPT-1 | ICD-A | RVS-4 | CPT-35 | ICD-D | RVS-8 |
| CPT-2 | ICD-B | RVS-6 | CPT-8 | ICD-W | RVS-4 |
| CPT-4 | ICD-D | RVS-8 | CPT-1 | ICD-A | RVS-6 |
| CPT-8 | ICD-W | RVS-50 | CPT-2 | ICD-B | RVS-50 |
| CPT-35 | | | CPT-4 | ICD-E | RVS-40 |
| | | | CPT-101 | ICD-F | |
| | | | CPT-230 | ICD-G | |
| | | | CPT-38 | ICD-H | |
| | | | CPT-67 | ICD-L | |
| | | | | ICD-P | |

What is claimed is:

1. A graphical user interface produced by an application program, comprising:
an application program window being generated by the application program on a computing device having a gesture-sensitive interface, the application program window enabling a user to search for CPT, ICD and RVS codes, the application window comprising a first sub-view, second sub-view, third sub-view, and forth sub-view;
wherein the first sub-view displays a vertically scrollable list of CPT values, each CPT value comprising, a CPT code, a CPT official description and one or more medical lingo terms associated to the CPT code;
wherein the second sub-view displays a vertically scrollable list of ICD values, each ICD value comprising, a ICD code, a ICD official description and one or more medical lingo terms associated to the ICD code;
wherein the third sub-view displays a vertically scrollable list of RVS values, each RVS value comprising, a RVS code, a RVS official description, and a relative value unit;
wherein the fourth sub-view displays a full-body anatomical representation of a human, the full-body anatomical representation being divided into gesture-sensitive regions such that each region is associated with zero to many CPT codes and zero to many medical lingo terms.

2. An apparatus for displaying CPT, ICD and RVS codes in an electronic anesthesia record, comprising:
means for displaying CPT search result values;
means for displaying ICD search result values;
means for displaying RVS search result values;
means for associating CPT codes to a region of an anatomical representation of the human body.

3. The apparatus as recited in claim 2, wherein the apparatus further includes a means of displaying ICD search results derived through a CPT to ICD crosswalk.

4. The apparatus as recited in claim 2, wherein the apparatus further includes a means of displaying CPT search results derived through an ICD to CPT crosswalk.

5. The apparatus as recited in claim 2, wherein the apparatus further includes a means of displaying CPT search results derived through an RVS to CPT crosswalk.

6. The apparatus as recited in claim 2, wherein the apparatus further includes a means of displaying CPT search results derived through a CPT to medical lingo relationship.

7. The apparatus as recited in claim 2, wherein the apparatus further includes a means of displaying ICD search results derived through an ICD to medical lingo relationship.

8. The apparatus as recited in claim 2, wherein the apparatus further includes a means of displaying CPT search results derived through a CPT to anatomical region relationship.

9. The apparatus as recited in claim 2, wherein the apparatus further includes a means of displaying CPT search results derived through a medical lingo to anatomical region relationship.

10. An apparatus for ordering CPT, ICD and RVS search results in an electronic anesthesia record, comprising:
means for ordering CPT search result values;
means for ordering ICD search result values;
means for ordering RVS search result values;

11. The apparatus as recited in claim 10, wherein the apparatus further includes a means of ordering search results based on previously saved CPT codes.

12. The apparatus as recited in claim 10, wherein the apparatus further includes a means of ordering CPT search results based on demographic information found in the electronic anesthesia record.

13. The apparatus as recited in claim 10, wherein the apparatus further includes a means of ordering CPT search results based on matches that occur at the beginning of words in the CPT official descriptions.

14. The apparatus as recited in claim 10, wherein the apparatus further includes a means of ordering CPT search results based on matches that occur at the beginning of medical lingo terms associated to one or more CPT codes.

15. The apparatus as recited in claim 10, wherein the apparatus further includes a means of ordering CPT search results based on CPT codes jointly derived from a search of CPT database and a CPT-ICD crosswalk.

16. The apparatus as recited in claim 10, wherein the apparatus further includes a means of ordering CPT search results based on CPT codes jointly derived from a search of CPT database and a CPT-RVS crosswalk.

17. The apparatus as recited in claim 10, wherein the apparatus further includes a means of ordering CPT search results based on CPT codes derived from CPT to anatomical region relationship.

18. The apparatus as recited in claim 10, wherein the apparatus further includes a means of ordering CPT search results based on CPT codes derived from medical lingo to anatomical region relationship.

19. The apparatus as recited in claim 10, wherein the apparatus further includes a means of ordering search results based on previously saved ICD codes.

20. The apparatus as recited in claim 10, wherein the apparatus further includes a means of ordering ICD search results based on demographic information found in the electronic anesthesia record.

21. The apparatus as recited in claim 10, wherein the apparatus further includes a means of ordering ICD search results based on matches that occur at the beginning of words in the ICD official descriptions.

22. The apparatus as recited in claim 10, wherein the apparatus further includes a means of ordering ICD search results based on matches that occur at the beginning of medical lingo terms associated to one or more ICD codes.

23. The apparatus as recited in claim 10, wherein the apparatus further includes a means of ordering ICD search results based on ICD codes jointly derived from a search of ICD database and a CPT-ICD crosswalk.

24. The apparatus as recited in claim 10, wherein the apparatus further includes a means of ordering search results based on previously saved RVS codes.

25. The apparatus as recited in claim 10, wherein the apparatus further includes a means of ordering RVS search results based on matches that occur at the beginning of words in the RVS official descriptions.

26. The apparatus as recited in claim 10, wherein the apparatus further includes a means of ordering RVS search results based on RVS codes jointly derived from a search of RVS database and a CPT-RVS crosswalk.
